(19) United States
(12) Patent Application Publication
(10) Pub. No.: US 2026/0322430 A1
(43) Pub. Date: Oct. 15, 2026

(54) METHOD AND SYSTEM FOR LOW OVERHEAD MIMO OFDM COMMUNICATION

(71) Applicant: INDIAN INSTITUTE OF TECHNOLOGY MADRAS (IIT Madras), Chennai (IN)

(72) Inventors: Radha Krishna GANTI, Chennai (IN); Aswathylakshmi. P, Kerala (IN)

(21) Appl. No.: 19/479,128

(22) PCT Filed: May 3, 2024
(86) PCT No.: PCT/IN2024/050477

§ 371 Date: Oct. 27, 2025

(30) Foreign Application Priority Data
May 4, 2023 (IN) 202341031828

(51) Int. Cl. H04B 7/0413

(52) U.S. Cl. CPC H04B 7/0413

(57) ABSTRACT

The present disclosure discloses a method for pilotless communication at a receiver in a wireless communication system. The method includes obtaining digital samples by sampling of a received signal. Further, the method includes determining a received signal matrix by arranging the digital samples based on a length of an orthogonal frequency division multiplexing (OFDM) symbol and a number of antennas. Further, the method includes constructing a set of potential initial points for transmitted signal components based on a singular vector decomposition (SVD) on the received signal matrix. Further, the method includes estimating a first set of points for transmitted signal components from the set of potential initial points based on at least one of: maximum angular variation in the set of potential initial points and a least circular area of the set of potential initial points.

### FIELD OF INVENTION

The present disclosure generally relates to wireless communication. More specifically, the present disclosure provides a method and a system for low overhead Multiple-Input Multiple-Output (MIMO) Orthogonal Frequency Domain Multiplexing (OFDM) communication.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

In wireless communication systems, reference signals known to both transmitter and receiver are used to estimate and mitigate the effects of channels on the received signal in order to decode the transmitted message. These reference signals, called pilots, use up valuable resources but do not contribute to the throughput of the system. They also add complexity to the system, especially in the case of a multi-user communication scenario such as cellular systems or WiFi.

Massive multiple-input-multiple-output (MIMO) uses a large number of antennas at the base station to multiplex multiple users on the same time-frequency resources. This maximizes spectrum usage while providing very high data rates in 5G new radio (NR) and 6G. The successful implementation of such a multi-user massive MIMO relies on the accurate estimation of the channel of each user. In 5G NR, channel estimation is accomplished using special symbols called pilots that are known to both the transmitter and the receiver.

These pilots are assigned to predesignated subcarriers. The symbols in these subcarriers do not carry information and therefore do not contribute to the system throughput. Since the pilot sequences assigned to simultaneously scheduled users must be orthogonal to each other to reduce interference, longer pilot sequences become necessary as the number of users supported by the massive MIMO system increases.

Moreover, in order to avoid pilot-data interference, subcarriers assigned to pilots for one user cannot be assigned as data subcarriers to another user simultaneously. These factors make pilot assignments in large multi-user systems challenging as well as impact the system throughput significantly. Various State-of-the-art provide various strategies for reducing pilot overhead.

According to one state-of-the-art, adaptive pilot patterns depending on users' Quality-of-Service (QoS) requirements or delay spread of the channel are proposed. However, they do not consider the interference from simultaneously scheduled users in a multi-user scenario.

According to another state-of-the-art, for a multi-user setting, a pilot length minimization technique is proposed, that makes use of the spatial correlation between the user's channels. However, this requires knowledge of user channel covariance matrices. In some state-of-the-art solutions, a pilot pattern adaptation scheme is proposed for users that are grouped and scheduled together on the basis of similar channel conditions. However, this imposes constraints on the scheduler and needs second-order statistics of all the users at the base station.

The above challenges of overhead and scheduling can be overcome by eliminating the need for pilots for channel estimation. In order to overcome issues a blind estimation technique is proposed in some of the state-of-the-art solutions. Blind estimation is a technique that does not rely on any pilots or prior knowledge of the channel or the signal. Instead, it exploits some inherent properties or statistics of the signal, to estimate the channel parameters.

For example, according to one state-of-the-art blind estimation technique, a blind amplitude and phase estimation technique using the cyclic prefix (CP) in the Orthogonal Frequency Division Multiplexed (OFDM) symbol is proposed. The technique works well for line-of-sight (LOS) and strongly correlated channels but becomes unstable for non-LOS (NLOS) channels.

According to another state-of-the-art blind estimation technique, an analytical multi-modulus technique is proposed for blind demodulation in time-varying Multiple Input and Multiple Output (MIMO) channels. In this technique, a batch analysis is required to be performed at the end of a blind source separation technique in order to resolve phase ambiguities and source permutations. The aforesaid method thus requires an additional resource for performing batch analysis.

According to yet another state-of-the-art blind estimation technique, a sparsity of massive MIMO channels is being exploited. According to the aforesaid method, a received signal matrix is being exploited to simultaneously estimate the signal and the channel using a modified approximate message passing technique. However, the method requires knowledge of prior distribution of the transmitted symbols and also requires some pilots to resolve phase and permutation ambiguities.

From the above it can be gathered that the existing state-of-the-art blind estimation techniques are computationally more complex and requires more processing time. Further, the existing blind estimation techniques are sensitive to noise, interference, or signal variations, which degrades the estimation accuracy.

Thus, there is a need to provide an improved blind estimation technique to mitigate the above-mentioned issues.

### OBJECTS OF THE INVENTION

The main objective of the present disclosure is to provide a wireless communication system that requires a minimum number of reference signals/pilots for channel estimation at a receiver.

Another objective of the present disclosure is to provide a method to blindly demodulate the received signals using an iterative technique that decomposes the received signal into a transmitted signal component and a channel component by appropriately satisfying initial point conditions and numerical stability conditions to guarantee convergence of the iterative technique.

Yet another objective of the present disclosure is to provide estimates that are scaled and/or rotated versions of the actual transmitted signal and channel.

Yet another objective of the present disclosure is to de-rotate the estimated transmitted signal using de-rotating techniques.

### SUMMARY OF THE INVENTION

The summary is provided to introduce aspects related to a method to provide a wireless communication system that requires a minimum number of reference signals/pilots for channel estimation at a receiver, and the aspects are further described below in the detailed description. This summary is not intended to identify essential features of the claimed subject matter nor is it intended for use in determining or limiting the scope of the claimed subject matter.

According to an embodiment, the present disclosure discloses a method for pilotless communication at a receiver in a wireless communication system. The method comprises obtaining digital samples by sampling of a received signal. Further, the method includes determining a received signal matrix by arranging the digital samples based on a length of an OFDM symbol and a number of antennas. Further, the method includes constructing a set of potential initial points for transmitted signal component based on a singular vector decomposition (SVD) on the received signal matrix. Further, the method includes estimating a first set of points for transmitted signal component from the set of potential initial points based on at least one of: maximum angular variation in the set of potential initial points and a least circular area of the set of potential initial points. Further, the method includes determining a first channel response based on at least one of the first set of points, the received signal, and a regularization parameter. Further, the method includes re-estimating, for a predefined number of iterations, a second set of points for transmitted signal component and a second channel response based on the first channel response, the first set of points, and the received signal. Further, the method includes reconstructing the received signal by de-rotating the second set of points for transmitted signal component by a scaling factor.

According to a further embodiment, constructing the set of potential initial points comprises performing the singular vector decomposition (SVD) on the received signal matrix (Y_{f}). Further, the method includes obtaining an orthogonal matrix of left singular vectors (U) based on the SVD on the received signal matrix (Y_{f}). Further, constructing a set of linear equations using a number of the top left singular vectors from the orthogonal matrix (U) which is equal to a number of users. Further, the method includes obtaining a set of modified top left singular vector by solving the set of linear equations constructed from the set of top left singular vectors using a single pilot signal per user. Further, the method includes performing a multiplication operation on a set of modified top left singular vectors of the orthogonal matrix (U) and a complex conjugate of a DFT matrix (F_{L}) and then constructing the set of potential initial points by multiplying a set of modified top left singular vector of an orthogonal matrix (U) with a complex conjugate of the DFT matrix (F_{L}).

According to a further embodiment, estimating the first set of points (\hat{X}) from the set of potential initial points based on maximum angular variation in the set of points comprises determining, the distribution of the angles of the potential initial points in the set of potential initial points with respect to a predefined constellation image. Further, the method includes determining the variance of the angular distribution of the potential initial points. Further, the method includes selecting from the set of potential initial points based on the variance of the angular distribution of the potential initial points with respect to the predefined constellation image, wherein points having the maximum angular variance in the set of potential initial points are estimated as the first set of points (\hat{X}).

According to a further embodiment, estimating the first set of points (\hat{X}) from the set of potential initial points based on the minimum circularity of the set of points comprises determining, a circularity of the set of points based on a ratio of an area and a perimeter of the set of points. Further, the method includes determining the least circular area of the set of points based on the circularity, wherein points in the set of potential initial points having the least circular area are estimated as the first set of points (\hat{X}).

According to a further embodiment, the second set of points are in a rotated order.

According to a further embodiment, de-rotating the second set of points comprises de-rotating, for a first time, the second set of points using a single pilot signal for each user, wherein the de-rotation of the second set of points for the first time is performed after completion of the predefined number of iterations. Further, the method includes obtaining one or more clusters from the second set of points using clustering techniques and the scaling factor for each user, wherein the number of clusters is based on the predefined constellation image. Further, the method includes plotting a line through one or more centroids of the one or more clusters for each user. Further, the method includes determining a residual correction factor for each user based on the slope of the line and de-rotating the second set of points based on the determined residual correction factor for each user.

According to a further embodiment, de-rotating the second set of points comprises de-rotating, for a first time, the second set of points using a single pilot signal and the scaling factor for each user. The de-rotation of the second set of points for the first time is performed after completion of a number of iterations which is less than the predefined number of iterations. The method further comprises estimating the second set of points for the first time based on the scaling factor and known information for each user. Further, the method includes performing demodulation and modulation on the second set of points for the first time for each user and re-performing the demodulation and the modulation on the second set of points for each iteration after de-rotation for the first time, until completion of the predefined number of iterations for each user. The second channel response, for a next iteration after a first iteration, is re-estimated based on the estimated second set of points for the first time.

According to a further embodiment, a plurality of rows in the received signal matrix (Y_{f}) corresponds to one or more subcarriers in a frequency domain and a plurality of columns corresponds to one or more antennas of the receiver. Further, the regularization parameter (μ) ranges from 0 to 0.5.

According to some embodiment, a receiver in a wireless communication system for pilotless communication is disclosed. The receiver comprises one or more processors configured to obtain digital samples by sampling of a received signal. Further, the one or more processors are configured to determine a received signal matrix (Y_{f}) by arranging the digital samples based on a length of an OFDM symbol (N) and a number of antennas (Nᵣ). Further, the one or more processors are configured to construct a set of potential initial points for transmitted signal component (\hat{X}) based on a singular vector decomposition (SVD) on the received signal matrix (Y_{f}). Further, the one or more processors are configured to estimate a first set of points for transmitted signal component (\hat{X}) from the set of potential initial points based on at least one of: maximum angular variation in the set of potential initial points and a least circular area of the set of potential initial points. Further, the one or more processors are configured to determine a first channel response ( [symbol] ) based on at least one of the first set of points (\hat{X}), the received signal, and a regularization parameter (μ). Further, the one or more processors are configured to re-estimate, for a predefined number of iterations, a second set of points (\hat{X}) for transmitted signal component and a second channel response based on the first channel response ( [symbol] ) the first set of points ((\hat{X}), and the received signal. Further, the one or more processors are configured to reconstruct the received signal by de-rotating the second set of points for transmitted signal component by a scaling factor (λ).

### BRIEF DESCRIPTION OF THE DRAWINGS

The accompanying drawings are included to provide a further understanding of the present disclosure and are incorporated in and constitute a part of this specification. The drawings illustrate exemplary embodiments of the present disclosure and, together with the description, serve to explain the principles of the present disclosure.

FIG. 1 illustrates a general OFDM system, according to an embodiment of the present disclosure.

FIG. 2 illustrates an operational flow in a MIMO OFDM communication system using the matrix decomposition technique, according to an embodiment of the present disclosure.

FIG. 3 illustrates method 300 for constructing the set of potential initial points, according to an embodiment of the present disclosure.

FIG. 4 illustrates method 400 for estimating the first set of points (\hat{X}) from the set of potential initial points based on maximum angular variation in the set of initial points, according to an embodiment of the present disclosure.

FIG. 5 illustrates the scatter plots of potential points constructed from a top left singular vector and different columns of the DFT matrix.

FIG. 6 illustrates method 600 for estimating the first set of points (\hat{X}) from the set of potential initial points based on circularity in the set of potential initial points, according to an embodiment of the present disclosure.

FIG. 7 illustrates scatterplots of the centroids with respect to the standard constellation, according to an embodiment of the present disclosure.

FIG. 8 illustrates centroids after final rotation.

FIG. 9 illustrates the constellations of \hat{X} obtained during various stages of technique depicted in Table 3, according to an embodiment of the present disclosure.

FIG. 10 illustrates a general block diagram of the transmitter/receiver, according to an embodiment of the present disclosure.

### DETAILED DESCRIPTION OF THE INVENTION

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Exemplary embodiments will now be described more fully hereinafter with reference to the accompanying drawings, in which exemplary embodiments are shown. This disclosure may however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

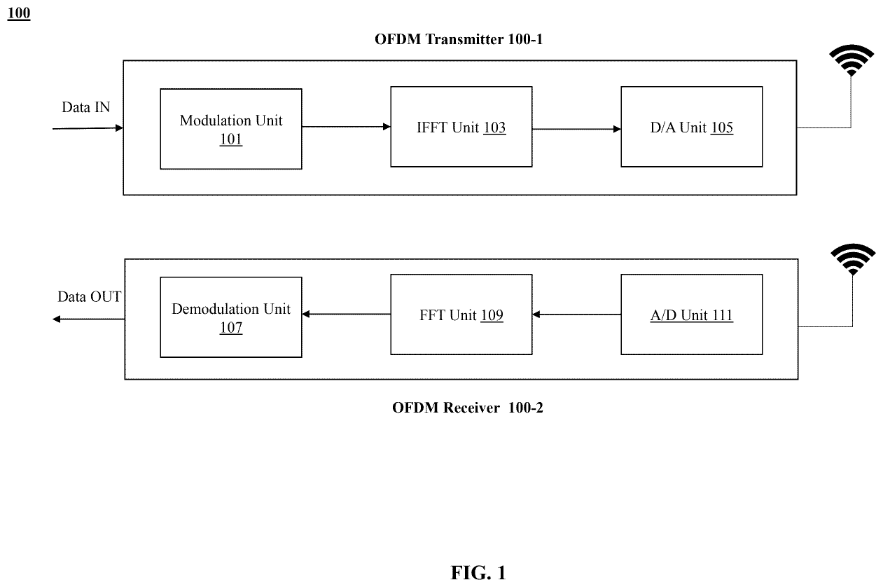

In one embodiment, a method for pilotless communication at a receiver in a wireless communication system is being disclosed. In a non-limiting example, the wireless communication may be an orthogonal frequency domain multiplexing (OFDM) system. FIG. 1 illustrates a general OFDM system, according to an embodiment of the present disclosure. In an embodiment, the OFDM system 100 includes an OFDM transmitter 100-1 and an OFDM receiver 100-2. In general, the OFDM transmitter 100-1 includes a modulation unit 101, an Inverse Fast Fourier Transform (IFFT) unit 103, and a Digital-to-Analog D/A unit 105. According to an embodiment, as input bit streams are received at the OFDM system 100, the input bit stream is demultiplexed into small bit streams. Further, each smaller bit stream is mapped to a complex symbol at modulation unit 101. In a non-limiting example, Quadrature Amplitude Modulation (QAM) modulation can be used for modulation. For the OFDM system, the complex symbols may be referred to as OFDM symbols. Further, the OFDM symbols are transformed from the frequency domain to the time domain using IFFT unit 103. The IFFT unit 103 further outputs and generates orthogonal subcarriers. The subcarriers are combined into a single OFDM signal for transmission by the D/A Unit 105.

In an embodiment, the OFDM receiver 100-2 includes a demodulation unit 107, an FFT unit 109, and an A/D unit 111. According to an embodiment, the OFDM signal or data signals are being received by the OFDM receiver 100-2. The received OFDM signal is converted back to parallel subcarriers. Further, the subcarriers are transformed from the time domain to the frequency domain using the Fast Fourier Transform (FFT) by the FFT unit 109. Further, each subcarrier is demodulated to recover the original symbols by the demodulation unit 107. The symbols are mapped back to bits and are combined to reconstruct an original bit stream.

In an embodiment, the present disclosure describes a transceiver/transmission reception/communication system that can decode a transmitted message by using a single reference signal for channel estimation. According to an embodiment, the disclosed method performs blind estimation of OFDM symbols using an alternating minimization framework. The method discloses an iterative method that decomposes the signal received (may be referred to as ‘received signal’) in a wireless communication system into a signal component and a channel component by solving a pair of optimization problems alternatingly.

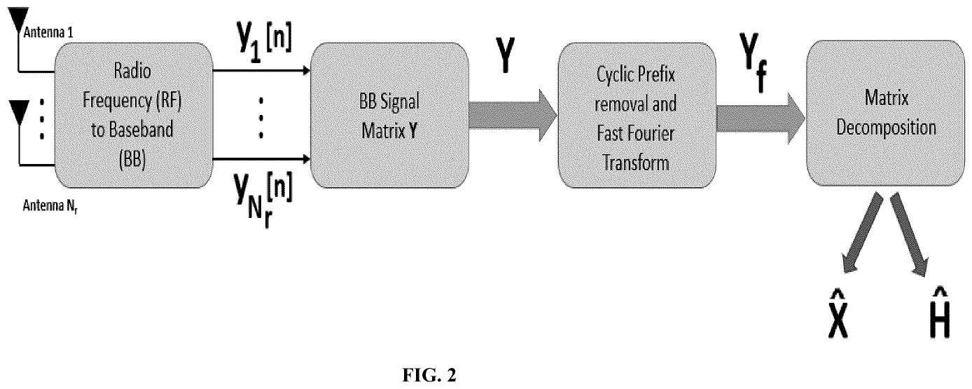

FIG. 2 illustrates an operational flow in a MIMO OFDM communication system using the matrix decomposition technique, according to an embodiment of the present disclosure. According to an example embodiment shown in FIG. 2, it is considered that the signals are received at a massive MIMO base station with Nᵣ antennas. The signals received at a receiver are from Nᵤ i.e. simultaneously scheduled users in an uplink. In an OFDM system, each user maps its bit-stream to an M-QAM constellation, and embeds them onto its allocated subcarriers, and further performs inverse fast Fourier transform (IFFT), and adds the cyclic prefix (CP) before transmission. According to an embodiment, the channel between each user and the base station is considered to have a maximum of L significant multi-paths. Thus, at the receiver, after sampling and CP removal, the signal received at antenna r at a sampling instant n is given by equation 1.

$${y}_{r} [ n ] = {\sum }_{u = 1}^{{N}_{u}} {x}_{u} [ n ] \text{?} {h}_{r , u} [ n ] = {w}_{r} [ n ] , \qquad ( 1 )$$

where xᵤ[n] is the OFDM symbol of user u, h_{r,u}[n] is the multi-path channel response between user u and antenna r, [symbol] represents circular convolution resulting from the cyclic prefix in OFDM, and wᵣ is the additive white circularly symmetric complex Gaussian noise (AWGN) at antenna r with variance σ².

According to an embodiment, it is considered that one OFDM symbol of length N was received across the Nᵣ antennas and arranged into the N×Nᵣ matrix (Y) given by equation (2). In an embodiment, the Y represents the received signal at each antenna over N sampling instants.

$$Y = {[ \begin{matrix}{y}_{1} [ 1 ] & {y}_{2} [ 1 ] & … & {y}_{{N}_{r}} [ 1 ] \\ {y}_{1} [ 2 ] & {y}_{2} [ 2 ] & … & {y}_{{N}_{r}} [ 2 ] \\ ⋮ & ⋮ & ⋱ & ⋮ \\ {y}_{1} [ N ] & {y}_{2} [ N ] & … & {y}_{{N}_{r}} [ N ]\end{matrix} ]}_{N \times {N}_{r}} \qquad ( 2 )$$

In equation 2, each column of Y represents the received signal at each antenna over N sampling instants. In an embodiment, the symbols/bit-stream of each user is blindly estimated from the received signal matrix, Y.

According to an embodiment of the present disclosure the received signal matrix, Y is decomposed into the user signal component and the channel component without the use of pilot symbols for estimating the channel. In an embodiment, the decomposition is based on a low-rank signal model for Y that takes into consideration the channel-hardening effect in massive MIMO systems. The decomposition based on the low-rank model has a denoising effect which is beneficial in blind demodulation. The structure of the low-rank signal model varies depending on the manner in which the different subcarriers in the OFDM symbol are allocated among the users.

According to an embodiment, the disclosed method can be implemented in a single-user scenario where the data in all N subcarriers in OFDM symbol originates from a single user/transmitter/source. According to an alternate embodiment, the disclosed method can be implemented in a multi-user MIMO (MU-MIMO) scenario where the data in all N subcarriers in OFDM symbol originates from multiple users/multiple transmitters/multiple sources. The forthcoming paragraph discloses the method of matrix decomposition in the single-user scenario.

In an embodiment, at first, the received signal matrix (Y) is expressed in a frequency domain by performing a Fast Fourier Transform (FFT) on the received signal matrix (Y). The FFT of Y is expressed in equation (3).

$${Y}_{f} = {X}_{f} {H}_{f} + {W}_{f} \qquad ( 3 )$$

In equation (3), the X_{f} is the N×N diagonal matrix with the N-length frequency-domain user data (which are the M-QAM symbols) as its diagonal, H_{f} denotes the channel in the frequency domain, and W_{f} is the noise in the frequency domain. The frequency-domain channel, H_{f} is the Fourier transform of the time-domain channel for the Nr antennas. Thus, for the L significant multi-paths in the channel, the time-domain channel matrix, denoted as Hₜ has only L non-zero rows corresponding to these paths. Therefore, H_{f} can be compactly expressed as the product of L columns of the N×N Discrete Fourier Transform (DFT) matrix, F_{L}, and the L×Nᵣ time-domain channel matrix, Hₜ, i.e., H_{f}=F_{L}Hₜ. The DFT matrix is a universally defined quantity for a given dimension. The DFT matrix of dimension N is being utilized. Thus, the low-rank signal model for Y_{f} is obtained and expressed in equation (4).

$${Y}_{f} = {X}_{f} {F}_{L} {H}_{f} + {W}_{f} \qquad ( 4 )$$

In equation (4), the F_{L} denotes the columns of the N×N DFT matrix corresponding to the delay of the L multi-paths in units of the sampling time. Hₜ denotes the L×Nᵣ time-domain channel response for the Nᵣ antennas, and W_{f} is the noise in the frequency domain. The L is the number of significant multipaths in the channel where L<<N is due to the channel hardening effect. Therefore, the product F_{L}Hₜ is the low-rank channel matrix in the frequency domain.

In an embodiment, the number of significant multi-paths is typically in the order of tens, even in rich scattering environments, since long paths and/or multiple reflections result in very high attenuation. This is much lower than N, the length of the OFDM symbol/FFT (which is of the order of thousands in 5G and 6G). It would also be lower than the number of antennas, Nᵣ in a massive MIMO setting with hundreds of antennas at the base station. Therefore, the above signal model suggests that while the rank of the received signal matrix, Y_{f} may be Nᵣ, the signal component of interest, X_{f} F_{L}Hₜ in it resides in a much smaller subspace of dimension L. This allows to estimate the correct signal subspace iteratively from Y_{f} using the method described in the forthcoming paragraphs, which also leads to the elimination of the noise in the other Nᵣ−L dimensions.

In a conventional system, pilots inserted in X_{f} are used to estimate the frequency-domain channel, H_{f} from Y_{f}. Then these channel estimates are used to decode the data X_{f} from Y_{f}. According to an embodiment of the present disclosure, the estimates of X_{f} and Hₜ are obtained without any pilots. These estimates \hat{X} and Ĥ can be obtained by solving the expression (5).

$$( \hat{X} , \hat{H} ) = {{argmin}_{X : N \times N {diagonal}_{l}}}_{H : L \times {N}_{r}} {‖ {Y}_{f} - {XF}_{L} H ‖}_{F}^{2} . \qquad ( 5 )$$

Conventionally solving the expression (5) gives rise to a non-convex problem in (X, H), but convex in individual variables. The alternating minimization technique simplifies the problem in (5) by solving for one variable at a time using the previous iterate for the second variable. According to an embodiment of the present disclosure, a modified iterative technique is disclosed that begins with an initial guess for \hat{X} and uses it to find Ĥ given by equation (6).

$$\hat{H} = {argmin}_{H} {‖ {Y}_{f} - \hat{X} {F}_{L} H ‖}_{F}^{2} \qquad ( 6 )$$

According to an embodiment, the linear least squares solution to (6) to estimate H is given by equation (7).

$$\hat{H} = {( \hat{X} {F}_{L} )}^{†} {Y}_{f} , \qquad ( 7 )$$

In equation (7), ‘†’ denotes the Moore-Penrose inverse. The Ĥ found in (7) is then used to solve equation (8).

$$\hat{X} = {argmin}_{x} {‖ {Y}_{f} - X {F}_{L} \hat{H} ‖}_{F}^{2} \qquad ( 8 )$$

According to an embodiment, a simplified solution of equation (8) is given by equation (9) and (10) while considering that \hat{X} needs to be diagonal, B=F_{L}Ĥ, and

$${a}_{n}^{T}$$

denote the n-th row of the matrix A.

$$\hat{X} = {argmin}_{x} {\sum }_{n = 1}^{N} {‖ {y}_{n}^{T} - x ( n ) {b}_{n}^{T} ‖}^{2} \qquad ( 9 )$$

$$= {argmin}_{x} {\sum }_{n = 1}^{N} {\sum }_{r = 1}^{{N}_{r}} {\vert y ( n , r ) - x ( n ) b ( n , r ) \vert}^{2} . \qquad ( 10 )$$

In equation (9), the x(n) denotes the n-th diagonal element of X, y(n, r) is the element at row n and column r of Y_{f}, and b(n, r) of equation (10) is the element at row n and column r of B. This gives the solution (11).

$$\hat{x} ( n ) = \frac{( {\sum }_{r = 1}^{{N}_{r}} y ( n , r ) {b}^{*} ( n , r ) )}{( {\sum }_{r = 1}^{{N}_{r}} {\vert b ( n , r ) \vert}^{2} )} \qquad ( 11 )$$

In equation (11), the \hat{x} (n) denotes the n-th diagonal element of \hat{X} and b*(n,r) denotes the complex conjugate of b(n,r). This technique is then iterated till the solution converges or for a fixed number of iterations.

In some scenarios, where the product \hat{X} F_{L}Ĥ needs to converge to Y_{f}, the iterative process can begin with any initial point since the convergence of the estimate \hat{X} to the actual transmitted X_{f} is not necessary in some cases. However, for a blind estimation technique, this convergence is paramount. In particular, for blind estimation, \hat{X} needs to converge to X_{f}. Therefore, the blind estimation techniques are required to satisfy certain initial point conditions and numerical stability conditions to guarantee convergence. Thus, one objective of the present disclosure is to find appropriate initial points so that the blind estimation technique converges while providing stability for the solutions.

According to an embodiment of the present disclosure, the alternating minimization technique begins with an initial guess for either \hat{X} or Ĥ, it then solves for the other using equations (7) or (11), respectively. If the initial point of the technique is orthogonal or nearly orthogonal to the quantity being estimated, the technique will never converge to X_{f} or Hₜ, as no amount of scaling or rotation can yield a vector in the orthogonal subspace. From equation (4) it is determined that X_{f} resides in the column space of Y_{f}, while Hₜ resides in the row space of Y_{f}. Since the left and right singular vectors of a matrix provide bases for its column space and row space, respectively, the technique analyses the singular value decomposition (SVD) of Y_{f} to devise a good initial point for the technique. In an embodiment, the receiver performs a singular vector decomposition (SVD) on Y_{f}. Thus, the SVD on Y_{f} is given by equation (12).

$${Y}_{f} = U Σ {V}^{H} \qquad ( 12 )$$

In equation (12), the U is the N×N orthogonal matrix of left singular vectors of Y_{f}, Σ is the N×Nᵣ truncated diagonal matrix of the corresponding singular values arranged in decreasing order, V is the Nᵣ×Nᵣ orthogonal matrix of the corresponding right singular vectors, and V^{H} denotes the conjugate transpose of V. According to an embodiment of the present disclosure a relationship between X_{f} and the left singular vectors in U is analyzed to determine points for \hat{X} to begin the alternating minimization technique. More particularly, a top singular vector in U is analyzed, as the top singular vector in U provides the direction of maximum variance in the data and therefore captures the most information.

In an embodiment, consider that the average powers of the L taps of the time-domain channel are ρ₁, ρ₂, . . . , ρ_{L}. Then the time-domain channel, Hₜ is expressed with expression (13).

$${H}_{t} = {[ \begin{matrix}\sqrt{{ρ}_{1}} & & \\ & ⋱ & \\ & & \sqrt{{ρ}_{L}}\end{matrix} ] [ \begin{matrix}{h}_{1 , 1} & {h}_{1 , 2} & … & {h}_{1 , {N}_{r}} \\ {h}_{2 , 1} & {h}_{2 , 2} & … & {h}_{2 , {N}_{r}} \\ ⋮ & ⋮ & ⋱ & ⋮ \\ {h}_{L , 1} & {h}_{L , 2} & … & {h}_{L , {N}_{r}}\end{matrix} ]}_{L \times {N}_{r}} \qquad ( 13 )$$

In equation (13), the h_{i,j} represents the channel coefficient for multi-path i and antenna j, with h_{i,j}∈CN (0, 1). Then the matrix Y_{f} is expressed as

$${Y}_{f} = {X}_{f} {F}_{L} {H}_{t} + {W}_{f} \qquad ( 14 )$$

$$= {X}_{f} [ {f}_{1} {f}_{2} … {f}_{L} ] [ \begin{matrix}\sqrt{{ρ}_{1}} & & \\ & ⋱ & \\ & & \sqrt{{ρ}_{L}}\end{matrix} ] [ \begin{matrix}{h}_{1} \\ {h}_{2} \\ ⋮ \\ {h}_{1}\end{matrix} ] + {W}_{f} \qquad ( 15 )$$

$$= {X}_{f} [ \sqrt{{ρ}_{1}} {f}_{1} {h}_{1} + \sqrt{{ρ}_{2}} {f}_{2} {h}_{2} + … + \sqrt{{ρ}_{L}} {f}_{L} {h}_{L} ] + {W}_{f} \qquad ( 16 )$$

In equations 14, 15, and 16, fᵢ (of dimension N×1) denotes column i of F_{L}, and hᵢ=[h_{i,1} h_{i,2} . . . h_{i,Nr}] for i=1, 2, . . . , L. If we assume that the channel taps are uncorrelated to each other, then equation (16) expresses the frequency-domain channel, H_{f}=Fₜ as a weighted summation of uncorrelated rank-1 N×Nr matrices, fᵢhᵢ. When the SVD is performed on Y_{f}, the top singular value, and the corresponding left and right singular vectors together

$$( {u}_{1} {σ}_{1} {v}_{1}^{H} )$$

capture the rank-1 N×Nᵣ matrix that is closest to Y_{f}. Equation (16) also allows to view Y_{f} as a weighted average of the data X_{f} distorted by the channel in different directions by the matrices fᵢhᵢ, weighted by the corresponding tap powers ρᵢ, for i=1, 2, . . . , L. If the time-domain channel has one clearly dominant tap (path) k that captures the majority of the channel energy, i.e., ρₖ>>ρᵢ, i=1, 2, . . . , L, i≠k, then

$${u}_{1} {σ}_{1} {v}_{1}^{H}$$

will be heavily skewed towards the rank-1 matrix \sqrt{ρₖ} X_{f}fₖhₖ. This allows to make the following approximation for the top left singular vector, u₁.

$${u}_{1} \approx {α}_{k} \sqrt{{ρ}_{k}} {X}_{f} {f}_{k} , \qquad ( 17 )$$

In equation 17, the αₖ∈C. If there are multiple dominant taps with similar powers, then u₁ will be approximately equal to the average of these directions, weighted by the corresponding tap powers. Thus, the convergence of the alternating minimization technique is guaranteed if the point satisfies the following conditions:
[symbol] X_{f}, \hat{X} [symbol] 0: \hat{X} should not be orthogonal to X_{f}, since the estimators in the technique do not yield a vector in the subspace orthogonal to the initial point.
∥\hat{X}−cX_{f}∥<δ, c∈C, δ>0: \hat{X} should be close to a complex scaled version of X_{f}.

In the scenario where (17) holds true, assuming tap k has the highest power, then the points for the technique is constructed as follows:

$$\hat{X} = diag ( {u}_{1} ⊙ {f}_{k}^{*} ) \qquad ( 18 )$$

In equation (18), ⊙ denotes element-wise multiplication and

$${f}_{k}^{*}$$

is the complex conjugate of fₖ. Since

$${f}_{k} ⊙ {f}_{k}^{*} = {[ 11 … 1 ]}_{1 \times N}^{T} ,$$

substituting equation (17) in equation (18) gives equation (19).

$$\hat{X} \approx diag ( {α}_{k} \sqrt{{ρ}_{k}} {X}_{f} {f}_{k} ⊙ {f}_{k}^{*} ) \approx {α}_{k} \sqrt{{ρ}_{k}} {X}_{f} \qquad ( 19 )$$

According to an embodiment, equation (19) provides an initial point such that it satisfies both the conditions listed above for the convergence of the technique.

According to an embodiment, construction of the initial point as given in equation (18) requires the base station to know which channel tap has the highest relative power as well as the delay of that tap (in units of the sampling time) in order to choose the correct column of F_{L} to be used. This can be obtained either from the Physical Random Access Channel (PRACH) or estimated from the top left singular vector u₁ using one of the methods described in the forthcoming paragraphs.

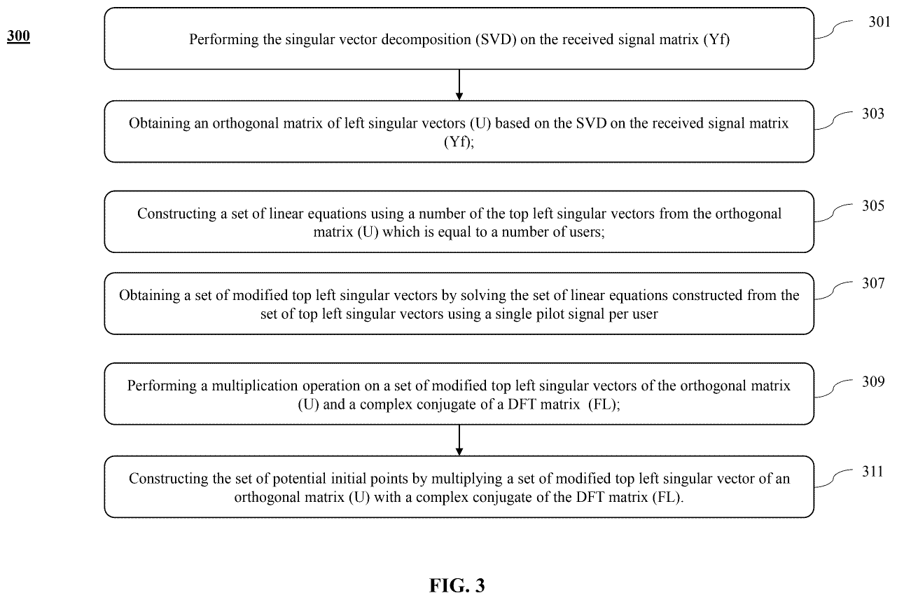

FIG. 3 illustrates method 300 for constructing the set of potential initial points, according to an embodiment of the present disclosure. According to an embodiment, method 300 is implemented at the receiver. An explanation of some of the steps is explained above, therefore the detailed explanation of the same is omitted here for the sake of brevity.

At step 301, method 300 includes performing the singular vector decomposition (SVD) on the received signal matrix (Y_{f}). Further, at step 303, method 300 includes obtaining an orthogonal matrix of left singular vectors (U) based on the SVD on the received signal matrix (Y_{f}). In an embodiment, the steps 301, and 303 are explained through equation (12). Further, at step 305, method 300 includes constructing a set of linear equations using a number of the top left singular vectors from the orthogonal matrix (U) which is equal to a number of users. Further, at step 307, method 300 includes obtaining a set of modified top left singular vectors by solving the set of linear equations constructed from the set of top left singular vectors using a single pilot signal per user. In an embodiment, step 305 corresponds to equations (41) and (42) and step 307 corresponds to equations (43), (44), and (45).

Further, at step 309, method 300 includes performing a multiplication operation on a set of modified top left singular vectors of the orthogonal matrix (U) and a complex conjugate of a DFT matrix (F_{L}). Further, at step 311, method 300 includes constructing the set of potential initial points by multiplying a set of modified top left singular vector of an orthogonal matrix (U) with a complex conjugate of the DFT matrix (F_{L}). The mathematical expression for steps 309 and 311 is given below, particularly in equation 20.

According to an embodiment, the receiver constructs the set of potential initial points, [symbol] , [symbol] , . . . [symbol] as given in equation (20).

$${\hat{X}}_{ι} = diag ( {u}_{1} ⊙ {f}_{i}^{*} ) , i = 1 , 2 , ⋯ , L \qquad ( 20 )$$

Assuming tap k has the highest power, the approximation of equation (17) is substituted in the above equation (20) to obtain equations (21) and (22).

$${\hat{X}}_{ι} \approx diag ( {α}_{K} \sqrt{{ρ}_{k}} {X}_{f} {f}_{k} ⊙ {f}_{i}^{*} ) \qquad ( 21 )$$

$$\approx diag ( {α}_{K} \sqrt{{ρ}_{k}} {X}_{f} {f}^{( k - i )} ) \qquad ( 22 )$$

In equations (21) and (22) f^{(k-i)} denotes the result of the element-wise multiplication fₖ⊙

$${f}_{i}^{*}$$

ω=e^{-j2π/N}, expressed in equation (23).

$${f}_{k} ⊙ {f}_{i}^{*} = {f}^{( k - i )} = [ \begin{matrix}1 \\ {ω}^{( k - i )} \\ {ω}^{2 ( k - i )} \\ ⋮ \\ {ω}^{( N - 1 ) ( k - i )}\end{matrix} ] \qquad ( 23 )$$

In an embodiment, when k≠i, the points in f^{(k-i)} which lie on the unit circle get scaled and rotated by the corresponding components of X_{f} in the expression (22). Therefore, the points in \hat{X}ₜ will be distributed in concentric circles of various radii around the origin of the Argand plane. However, when k=i, f^{(k-i)} collapses to a vector of ones, resulting in the desired point given in equation (19). Thus, the scatter-plot of [symbol] will strongly resemble the QAM constellation of X_{f} (although scaled and rotated).

According to an embodiment, a resemblance of the potential initial points to a QAM constellation is to be quantified in order to pick the correct one. According to an embodiment, based on one of angular variation or circular area in the potential initial points, a set of points can be estimated. Since the points in \hat{X}ᵢ, i≠k is distributed in concentric circles around the origin, the angles of these points are then distributed almost uniformly in all directions. However, when resembling a QAM constellation, the points in [symbol] will be concentrated in certain directions more than the others, resulting in a higher variance for the angular distribution. Therefore, the tap corresponding to the \hat{X}ₜ with the highest variance in angular distribution is deemed the dominant tap and used for the initial point of the technique.

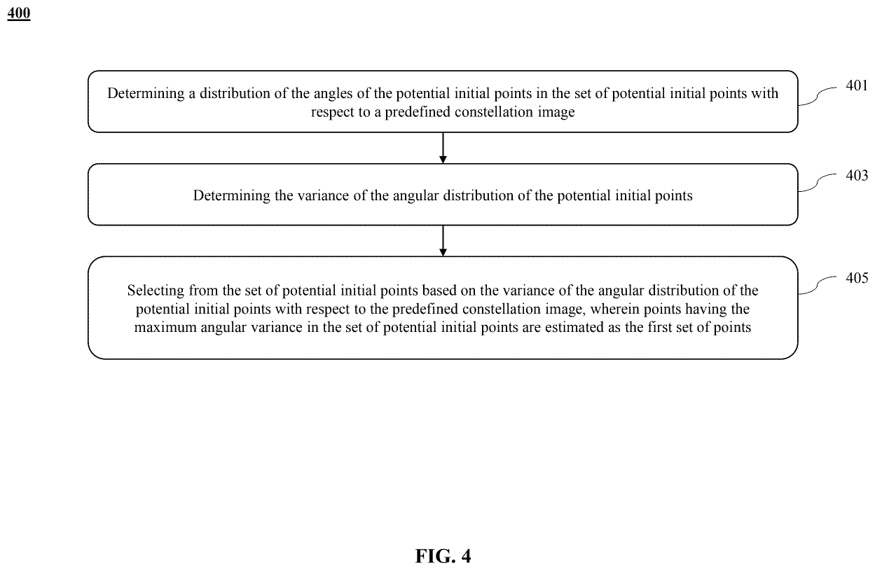

FIG. 4 illustrates method 400 for estimating the first set of points (\hat{X}) from the set of potential initial points based on maximum angular variation in the set of initial points, according to an embodiment of the present disclosure. According to an embodiment, method 400, at step 401 includes determining a distribution of the angles of the potential initial points in the set of potential initial points with respect to a predefined constellation image. Further, method 400, at step 403 includes determining a variance of the angular distribution of the potential initial points. Further, method 400, at step 405 includes selecting from the set of potential initial points based on the variance of the angular distribution of the potential initial points with respect to the predefined constellation image. Thus, the points having the maximum angular variance in the set of potential initial points are estimated as the set of points.

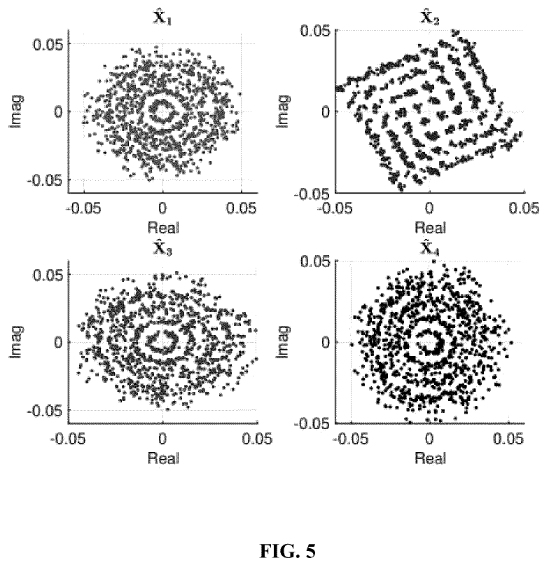

FIG. 5 illustrates the scatter plots of potential points constructed from a top left singular vector and different columns of the DFT matrix. As can be seen, the scatter-plot of [symbol] resembles the QAM constellation of X_{f}. In an embodiment, the scatter-plot of potential initial points constructed from u₁ and different columns of the DFT matrix, F_{L} as per (20) for a 4-tap channel with the second tap having the highest relative power. When u₁ is multiplied with the conjugate of the column of F_{L} corresponding to the dominant tap (second tap in the above case), the initial point strongly resembles a QAM constellation. Accordingly, the points having the maximum angular variance in the set of potential initial points are estimated as the first set of points.

The procedure for estimation of the first set of points based on angular variance is summarized in Table 1. According to some embodiment, the determination of the angular distribution may be performed based on any image analysis techniques.

TABLE 1
1: Input u₁, F_{L} = [f₁ f₂ . . . f_{L}].
2: for i ← 1 to L do
3: Construct \hat{X}ᵢ ← diag(u₁ ⊙ fᵢ).
4: Calculate angular distribution,
Aᵢ ← histogram {∠\hat{χ}ᵢ(n), n = 1, 2, . . . , N}.
5: Calculate var(i) = variance {Aᵢ}
6: end for
7: k ← argmax var
8: return Initial point, \hat{X} = \hat{X}ₖ

According to an embodiment, in the multi-user scenario, a robust estimation is required due to the high amount of interference. Due to the high amount of interference, the estimation errors increase. In such a case, binary image classification-based methods can be applied to find the dominant tap. Referring back to FIG. 5, it can be seen that the scatter-plots of \hat{X}ᵢ where i≠k resemble circles whereas the outline of the scatter-plot of the correct initial point, [symbol] resembles a square (for input QAM constellations). Therefore, the circularity of the scatter-plots can be measured for estimating the set of points using the fact that the shape which maximizes area for a given perimeter is the circle. The tap that leads to the least circular scatter-plots in equation (20) is estimated as the dominant tap.

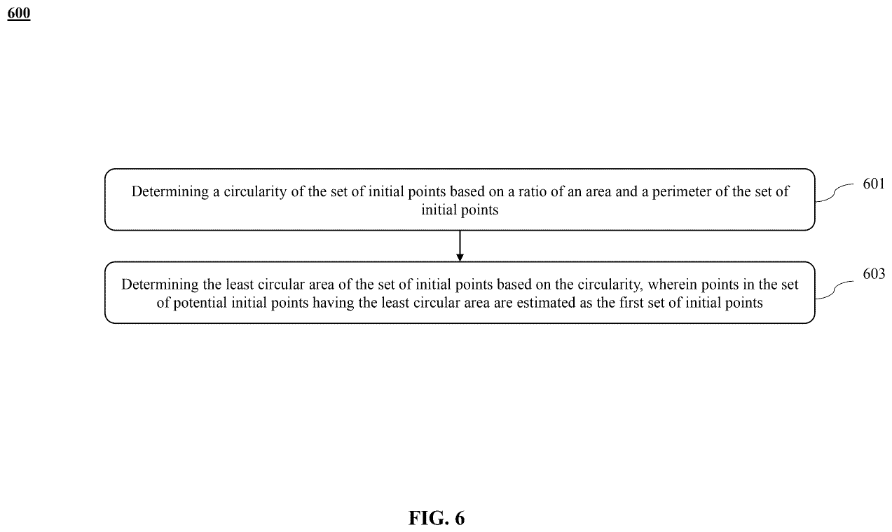

FIG. 6 illustrates method 600 for estimating the first set of points (\hat{X}) from the set of potential initial points based on circularity in the set of initial points, according to an embodiment of the present disclosure. According to an embodiment, after obtaining the potential initial points, boundary points of the potential initial points are obtained. Further, a perimeter and an area of the set of initial points forming the circle is determined. Further, method 600, at step 601, includes determining a circularity of the set of initial points based on a ratio of the area and the perimeter of the set of initial points. Further, at step 603, method 600 includes determining the least circular area of the set of initial points based on the circularity. Thus, the points in the set of potential initial points having the least circular area are estimated as the first set of points. The procedure for estimation of the point based on circularity is summarized in Table 2.

```
TABLE 2
  1: Input u₁, F_{L} = [f₁ f₂ ... f_{L}].
  2: for i ← 1 to L do
  3: Construct \hat{X}ᵢ ← diag(u₁ ⊙ fᵢ).
  4: Find the boundary points of \hat{X}ᵢ → boundary(\hat{X}ᵢ).
  5: Calculate perimeter(i) from boundary(\hat{X}ᵢ).
  6: Calculate area(i) enclosed by boundary(\hat{X}ᵢ).
  7:  $Calculate circularity ( i ) = \frac{4 πarea ( i )}{{( perimeter ( i ) )}^{2}} .$
  8: end for
  9: k ← argmin circularity
10: return Initial point, \hat{X} = \hat{X}ₖ
```

According to an embodiment, the points \hat{X} as determined above becomes an initial guess for the blind estimation technique. According to an embodiment, a channel response ( [symbol] ) is further determined based on at least one of the set of points (\hat{X}), the received signal (Y_{f}), and a regularization parameter (μ) iteratively. Accordingly, the blind estimation technique can blindly estimate the user symbols and channels with guaranteed convergence.

Table 3 illustrates procedures for modified blind estimation for determining the user symbols and channels. As can be seen in step 1, the set of points (\hat{X}), the received signal (Y_{f}), a predefined number of iterations (T), a pilot subcarrier (p), pilot symbol x(p), and the regularization parameter (μ). In an embodiment, after initialization, the channel response ( [symbol] is calculated at a first iteration at steps 4 and 5. Now, as the channel response (let's say ( [symbol] is calculated at the first iteration. At this stage, the technique calculates again the set of points (\hat{X}) using ( [symbol] ) based on the equation depicted in step 7. In an embodiment, the estimation for the set of points (\hat{X}) for the first iteration lets say ( [symbol] calculated at step 7 is again used for calculating the channel response (let's say ( [symbol] in a next iteration. Thus, as the \hat{X} is repetitively estimated at step 7, the \hat{X} becomes more closer to the actual points.

```
TABLE 3
  1: Input Y_{f}, initial point \hat{X}, number of iterations T, pilot
    subcarrier p, pilot symbol x(p), regularization parameter
    μ
  2: Initialize k = 1, B = [ ]
  3: repeat
  4:  $\hat{H} ← {( {F}_{L}^{H} {\hat{X}}^{H} \hat{X} {F}_{L} + μI )}^{- 1} {F}_{L}^{H} {\hat{X}}^{H} {Y}_{f}$
  5: B ← F_{L}H
  6: for n ← 1 to N do
  7:  $\hat{x} ( n ) = \frac{( {\sum }_{r = 1}^{{N}_{r}} y ( n , r ) {b}^{*} ( n , r ) )}{( {\sum }_{r = 1}^{{N}_{r}} {\vert b ( n , r ) \vert}^{2} )}$
  8: end for
  9: if k > 3 then
10: if k = 4 then
11: λ ← \hat{x}(p)/x(p)
12: \hat{X} = \hat{X}/λ
13: end if
14: QAM demodulate \hat{X} → \hat{X}_{d}
15: QAM modulate \hat{X}_{d} → \hat{X}
16: end if
17: k ← k + 1
18: until k = T
19: return \hat{X}, Ĥ
```

In an embodiment, the process from steps 4 to 7 is iteratively performed for the pre-defined number of iterations. According to an embodiment, the final set of points is obtained after the completion of the predefined number of iterations. In an embodiment, the final set of points are in a rotated order, and therefore required to be de-rotated.

According to an embodiment, the de-rotation may be performed after the completion of the predefined number of iterations. Further, according to some embodiment, the de-rotation may be performed after performing a few number of iterations which is less than the predefined number of iterations. The forthcoming paragraphs describe the two techniques to de-rotate the set of points.

In an embodiment, after the completion of the predefined number of iterations, the receiver de-rotates the final set of points using a single pilot signal. Further, the receiver obtains the one or more clusters from the final set of points using clustering techniques and the scaling factor (λ). In particular, the disclosed method utilizes a Lloyd's k-means clustering technique with the number of clusters equal to the modulation order, M, and the standard M-QAM constellation rotated by λ estimated from the single rotational pilot as the initial centroids

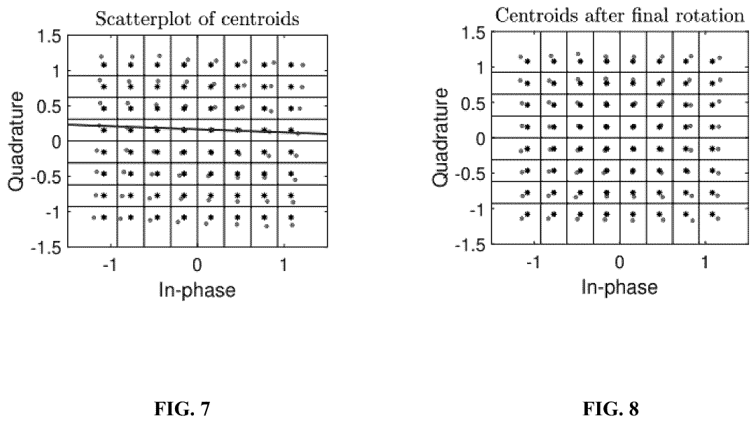

FIG. 7 illustrates scatterplots of the centroids with respect to the standard constellation, according to an embodiment of the present disclosure. In FIG. 7, centroids (in red) of the clusters were obtained using Lloyd's k-means technique. Further, points in black correspond to the standard 64-QAM constellation. The slope of the line through a row of centroids (in blue) gives a residual rotation to be corrected. In cases where a single rotational pilot is heavily corrupted by noise, the residual rotation might be very high, causing even the centroids of some of the clusters to be demodulated incorrectly. To mitigate this, a residual correction factor is required to be determined to compensate for the residual rotation.

According to an embodiment of the present disclosure, the method then includes plotting a line (i.e. blue as shown in FIG. 7) through one or more centroids of the one or more clusters. Further, the method includes determining a residual correction factor based on the slope of the line. Accordingly, the final set of points is based on the determined residual correction factor. FIG. 8 illustrates centroids after final rotation. Table 4 illustrates a summarized procedure of de-rotation using clustering techniques.

```
TABLE 4
  1: Input \hat{X} (after alternating minimization), pilot subcarrier
    p, pilot symbol x(p), modulation order M
  2: Calculate initial rotation, λ = x(p)/\hat{x}(p)
  3: Define Q ← M-QAM constellation
  $4 : Rotate ( \frac{1}{λ} ) Q \to {Q}_{r}$
  5: Input to Lloyd’s k-means algorithm: \hat{X}, M clusters, initial
    centroids Qᵣ
  6: Output of Lloyd’s algorithm: Φ ← Cluster indices for \hat{X},
    C ← Final centroids
  7: De-rotate λC → Cᵣ
  8: Find points P = {cᵣ ∈ closest Voronoi regions above
    real-axis for Q}
  9: Calculate θ slope of line fit through P
$10 : Define rotation matrix , Θ = [ \begin{matrix}cos ( θ ) & - sin ( θ ) \\ sin ( θ ) & cos ( θ )\end{matrix} ]$
11: De-rotate Cᵣ Θ → C_{final}
12: M-QAM demodulate C_{final} → C_{QAM}
13: Demodulate Φ using C_{QAM} → Φ_{QAM}
14: return Φ_{QAM}
```

According to a further embodiment, an alternative method for correcting the rotation is executed within the alternating minimization framework. That is, the de-rotation is performed after performing a few number of iterations which is less than the predefined number of iterations. This technique effectively works for higher order modulations. The error rate drops steeply in the first few iterations after which the slope of the curve decreases. This happens because after the first few iterations, the QAM constellation has been almost fully recovered by the technique, however the error due to residual rotation of the constellation remains. Therefore, after the first few iterations of alternating minimization, X using the one pilot is calculated to correct the estimated rotation. Then after applying a couple of operations on the recovered constellation in all the subsequent iterations of alternating minimization, the residual rotation is successively corrected. This consists of QAM demodulation followed by QAM modulation of the \hat{X} after each alternating minimization, and then feeding the “clean” QAM constellation closest to \hat{X} for the next iteration. This boosts the overall SNR of the constellation as most of the points are demodulated correctly at this stage, eliminating the noise power in them, and only a few points are demodulated incorrectly due to the residual rotation. The next iteration of alternating minimization is then able to correct these erroneous points due to the SNR boost from the correctly demodulated points. This process is continued for a few more iterations to ensure that any residual rotation has been fully corrected.

According to an embodiment, the de-rotation is performed, for a first time, on the set of points using a single pilot signal and the scaling factor where the de-rotation of the set of points for the first time is performed after completion of the number of iterations which is less than the predefined number of iterations. Further, the method includes de-rotating the set of points for the first time based on the scaling factor and known information. Further, the method includes performing demodulation and modulation on the set of points that is obtained after de-rotation for the first time. Further, the method includes re-performing the demodulation and the modulation on the set of points for each iteration after de-rotation for the first time until completion of the predefined number of iterations for each user. Thus, the channel response, for a next iteration after a first iteration, is re-estimated based on the estimated set of points for the first time.

Table 3 summarizes a modified alternating minimization technique. Referring back to Table 3, as can be seen for the few iterations here till k>3, steps 3 to 7 are performed. Thereafter, with the set of points obtained at k=4, the de-rotation is performed for the first time. Accordingly, steps 10 to 15 are performed for the first time. Further, the QAM modulated output of step 15 is then used by step 4 to calculate the Ĥ and \hat{X} iteratively for the predefined number of iterations. In particular, step 14 and 15 are performed after steps 4 to 7 for every iteration i.e. after iteration K=4 until the predefined number of iterations are completed. After completion of the predefined number of iterations, the received signal is reconstructed.

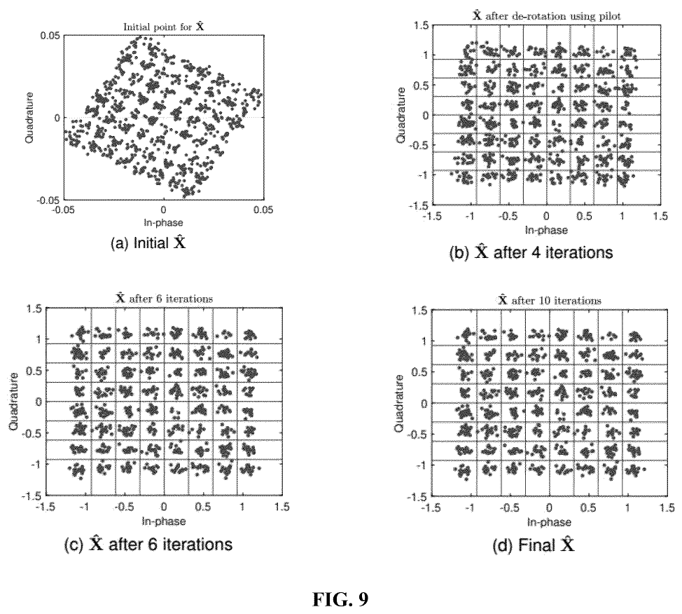

FIG. 9 illustrates the constellations of \hat{X} obtained during various stages of the technique depicted in Table 3, according to an embodiment of the present disclosure. FIG. 9(a) is the initial point obtained from the top left singular vector of Y_{f}. After 4 iterations of alternating minimization, the scaling/rotation factor, λ estimated using the pilot symbol as per step 11 of the technique is used for de-rotating the constellation, which is given in FIG. 9(b). Then demodulation and modulation are applied on this constellation as per steps 14 and 15 of the technique along with the alternating minimization. The constellation obtained after 6 iterations is given in FIG. 9(c), where it is observed that the combination of demodulation and modulation continues to correct the residual rotation. Finally, after 10 iterations, when the technique stops, and the resulting constellation is given in FIG. 9(d).

According to an embodiment, the regularization parameter (μ) is determined to be in the range of 0 to 0.5, as the said range ensure numerical stability in the Ĥ. Further, the scaling factor λ is determined using single pilot symbol embedded in the frequency domain data that is known to the receiver. According to an embodiment, the scaling factor can be estimated with equation 24.

$$\hat{λ} = \frac{1}{η} {\sum }_{i = 1}^{η} \frac{\hat{x} ( {p}_{i} )}{{P}_{i}} . \qquad ( 24 )$$

In equation 23, η is the number of pilots (equal to 1 for a single pilot), pᵢ∈{1, . . . , N} denote the location of the i-th rotational pilot and Pᵢ is its complex value which is known both at the transmitter and the receiver. The forthcoming paragraphs will now disclose the blind estimation in the multi-user scenario.

According to some embodiment, in the multi-user MIMO scenario, the N subcarriers of the OFDM symbol contain data from multiple users in an overlapping manner. Now consider that there are Nᵤ single-antenna users scheduled simultaneously in one OFDM symbol, then the received signal matrix in the frequency domain becomes

$${Y}_{f} = {\sum }_{u = 1}^{{N}_{u}} {X}_{f} ( u ) {F}_{L} {H}_{t} ( u ) + {W}_{f} \qquad ( 25 )$$

In equation 25, where X_{f}(u) denotes the N×N diagonal matrix with the frequency domain (M-QAM) symbols of user u as its diagonal, and Hₜ(u) is the L×Nᵣ time-domain channel matrix of user u. In an embodiment, a maximum of L multi-paths for each user is considered. Conventionally, orthogonal pilot sequences would be assigned to these Nᵤ users for estimation of their respective channels and consequent decoding of the data. Moreover, the subcarriers assigned for the pilots of any user cannot be assigned for data of any other user to avoid pilot-data interference, resulting in wastage of spectrum. Thus, the objective, is to blindly estimate X_{f} (u) and Hₜ (u) for u=1, 2, . . . , Nᵤ without such pilot sequences. Thus, the following notation to expresses this objective function in a form similar to (5) used for the single-user, and the equation (25) is rewritten as.

$${Y}_{f} = [ {X}_{f} ( 1 ) {X}_{f} ( 2 ) … {X}_{f} ( {N}_{u} ) ] diag ( {F}_{L} ) [ \begin{matrix}{H}_{t} ( 1 ) \\ {H}_{t} ( 2 ) \\ ⋮ \\ {H}_{t} ( {N}_{u} )\end{matrix} ] + {W}_{f} \qquad ( 26 )$$

$$where diag ( {F}_{L} ) is the block matrix$$

$$diag ( {F}_{L} ) = {[ \begin{matrix}{F}_{L} & 0 & . & . & . & 0 \\ 0 & {F}_{L} & . & . & . & 0 \\ . & . & . & & & . \\ . & . & & . & & . \\ . & . & & & . & . \\ 0 & 0 & . & . & . & {F}_{L}\end{matrix} ]}_{{NN}_{u} \times L {N}_{u}}$$

According to an embodiment, the transmitted signal component estimate of user u is denoted by the N×N diagonal matrix \hat{X} (u), the time-domain channel estimate of user u by the L×Nᵣ matrix Ĥ(u), and let \hat{X}=[\hat{X}(1) \hat{X} (2) . . . \hat{X} (Nᵤ)] and Ĥ=[Ĥ(1)^{T} Ĥ(2)^{T} . . . Ĥ(Nᵤ)^{T}]^{T} Thus, \hat{X} and Ĥ is estimated such that

$${‖ {Y}_{f} - X \text{?} ( {F}_{L} ) \hat{H} ‖}_{F}^{2}$$

is minimized, which is similar to (5).

According to an embodiment, a similar alternating minimization approach is used to solve the problem by assuming an initial value for \hat{X} and finding the Ĥ that satisfies the below equation.

$$\hat{H} = {arg min}_{X} {‖ {Y}_{f} - \hat{X} diag ( {F}_{L} ) H ‖}_{F}^{2} . \qquad ( 28 )$$

The regularized linear least squares solution for (28) is given below.

$$\hat{H} = {( \hat{X} diag ( {F}_{L} ) )}^{†} {Y}_{f} , \qquad ( 29 )$$

In an embodiment, with the regularization term μI_{LN}_{ᵤ} included in the pseudo-inverse, and applying the Ĥ in (29) to find the \hat{X} that minimizes as below.

$$\hat{X} = {arg min}_{X} {‖ {Y}_{f} - X diag ( {F}_{L} ) \hat{H} ‖}_{F}^{2} . \qquad ( 30 )$$

In an embodiment, the frequency-domain channel estimate of each user is denoted by B(u)=F_{L}Ĥ(u) so that

$$B = diag ( {F}_{L} ) \hat{H} = {[ {B ( 1 )}^{T} {B ( 1 )}^{T} … {B ( {N}_{u} )}^{T} ]}^{T} \qquad ( 31 )$$

The solution to (30), \hat{X} has to be in the form of Nᵤ diagonal N×N matrices stacked horizontally. Substituting (31) in (30) equation (32) is obtained.

$$\begin{matrix}{‖ {Y}_{f} - X diag ( {F}_{L} ) \hat{H} ‖}_{F}^{2} = {‖ {Y}_{f} - XB ‖}_{F}^{2} , \\ = {\sum }_{n = 1}^{N} {‖ {y}_{n}^{T} - {\hat{x}}^{T} ( n ) {B}_{n} ‖}_{2}^{2}\end{matrix} , \qquad ( 32 )$$

In equation (32)

$${y}_{n}^{T}$$

is the n-th row of Y_{f}, is a row vector made up of the n-th diagonal element of each user data estimate \hat{X}(u), i.e., \hat{x}^{T}(n)=[\hat{x}ₙ(1), \hat{x}ₙ(2), . . . , \hat{x}ₙ(Nₙ)], and Bₙ is the Nᵤ×Nᵣ matrix obtained by stacking the n-th row of B(u), for u=1, 2, . . . , Nᵤ, vertically. Here,

$${y}_{n}^{T}$$

is the received signal at the Nᵣ antennas for the n-th subcarrier \hat{x}^{T}(n), represents the estimated transmitted signal on the n-th subcarrier for all the users, and Bn is the estimated frequency-domain channel matrix for the n-th subcarrier for all the users. Thus, for each subcarrier n∈1, 2, . . . , N, this leads to the linear least squares solution.

$${\hat{x}}^{T} ( n ) = {{y}_{n}^{T} ( {B}_{n} )}^{†} . \qquad ( 33 )$$

The solutions given in (29) and (33) are calculated alternately and iterated until the solutions converge or for a fixed number of iterations. Similar to the single-user case discussed in the above paragraphs, the convergence again hinges on the initial point used for \hat{X}, the estimation of which is described in the forthcoming paragraphs.

According to an embodiment, for initial point calculation in multi-user scenario, once again turn to the SVD of Y_{f}, specifically the left singular vectors that span the column space of Y_{f} which contains the user symbols X_{f}(1), X_{f}(2), . . . , X_{f}(Nᵤ). According to an embodiment, break down the channel of each user to gain insights about the left singular vectors in the multi-user scenario.

According to an embodiment, consider that the average tap powers of user u's time-domain channel be

$${ρ}_{1}^{u} , {ρ}_{2}^{u} , … , {ρ}_{L}^{u} .$$

Then the time-domain channel of user u is given by

$${H}_{t} ( u ) = [ \begin{matrix}\sqrt{{ρ}_{1}^{u}} & & \\ & ⋱ & \\ & & \sqrt{{ρ}_{L}^{u}}\end{matrix} ] [ \begin{matrix}{h}_{1}^{u} \\ {h}_{2}^{u} \\ ⋮ \\ {h}_{L}^{u}\end{matrix} ] , \qquad ( 34 )$$

In equation (34)

$${h}_{1}^{u} = [ {h}_{1 , 1}^{u} , {h}_{1 , 2}^{u} , … … {h}_{1 , {N}_{r} ,}^{u} ]$$

are user u's channel coefficients for the Nᵣ antennas through path i, and the frequency-domain channel is given by equations (35)-(38). Further, analyzing the relationship between the left singular vectors of Y_{f} and the expression in (38). Considering the case where all the Nᵤ users have the same power and similar channel power delay profiles.

$$\begin{matrix}{F}_{L} {H}_{t} ( u ) & = & [ \begin{matrix}{f}_{1} & {f}_{2} & … & {f}_{L}\end{matrix} ] [ \begin{matrix}\sqrt{{ρ}_{1}^{u}} & & \\ & ⋱ & \\ & & \sqrt{{ρ}_{L}^{u}}\end{matrix} ] [ \begin{matrix}{h}_{1}^{u} \\ {h}_{2}^{u} \\ ⋮ \\ {h}_{L}^{u}\end{matrix} ] & ( 35 ) \\ & = & [ \sqrt{{ρ}_{1}^{u}} {f}_{1} {h}_{1}^{u} + \sqrt{{ρ}_{2}^{u}} {f}_{2} {h}_{2}^{u} + … + \sqrt{{ρ}_{L}^{u}} {f}_{L} {h}_{i}^{u} ] . & ( 36 )\end{matrix}$$

$$Therefore , {Y}_{f} can be expressed as$$

$$\begin{matrix}{Y}_{f} & = & {\sum }_{u = 1}^{{N}_{u}} {X}_{f} ( u ) {F}_{L} {H}_{t} ( u ) + {W}_{f} & ( 37 ) \\ & = & {\sum }_{u = 1}^{{N}_{u}} {X}_{f} ( u ) ( {\sum }_{i = 1}^{L} \sqrt{{ρ}_{i}^{u}} {f}_{i} {h}_{i}^{n} ) + {W}_{f} . & ( 38 )\end{matrix}$$

If it is assumed that tap k is the dominant tap for all the users, i.e.

$${ρ}_{k}^{u} ≫ {ρ}_{i}^{u} , i = 1 , 2 , … , L , i , \neq k , u = 1 , 2 , … , {N}_{u} , \qquad ( 39 )$$

then there are Nᵤ directions which have a similar fraction of the power in Y_{f}, given by equation 40, corresponding to each user's dominant tap. These directions are captured by the top Nᵤ singular vectors of Y_{f}. However, the singular vectors will be a linear combination of these directions (due to the orthogonality constraints of the SVD).

$$\sqrt{{ρ}_{k}^{u}} {X}_{f} ( u ) {f}_{k} {h}_{k}^{u} , \qquad ( 40 )$$

Thus, it is expressed as a system of linear equations for the left singular vectors uⱼ, j=1, 2, . . . , Nᵤ where

$${u}_{j} \approx {α}_{j}^{1} {X}_{f} ( 1 ) {f}_{k} + {α}_{j}^{2} {X}_{f} ( 2 ) {f}_{k} + … + {α}_{j}^{{N}_{u}} {X}_{f} ( {N}_{u} ) {f}_{k} . \qquad ( 41 )$$

The equation 41 can be expressed in the matrix notation as

$$[ \begin{matrix}{u}_{1}^{T} \\ {u}_{2}^{T} \\ ⋮ \\ {u}_{{N}_{u}}^{T}\end{matrix} ] \approx [ \begin{matrix}{α}_{1}^{1} & {α}_{1}^{2} & … & {α}_{1}^{{N}_{u}} \\ {α}_{2}^{1} & {α}_{2}^{2} & … & {α}_{2}^{{N}_{u}} \\ ⋮ & ⋮ & ⋱ & ⋮ \\ {α}_{{N}_{u}}^{1} & {α}_{{N}_{u}}^{2} & … & {α}_{{N}_{u}}^{{N}_{u}}\end{matrix} ] [ \begin{matrix}{( {X}_{f} ( 1 ) {f}_{k} )}^{T} \\ {( {X}_{f} ( 2 ) {f}_{k} )}^{T} \\ ⋮ \\ {( {X}_{f} ( {N}_{u} ) {f}_{k} )}^{T}\end{matrix} ] \qquad ( 42 )$$

Using A to denote the matrix of linear coefficients (whose estimation is described in the upcoming paragraphs section), an equation (43) is determined.

$$[ \begin{matrix}{Z}^{T} ( 1 ) \\ {Z}^{T} ( 2 ) \\ ⋮ \\ {Z}^{T} ( {N}_{u} )\end{matrix} ] = {A}^{- 1} [ \begin{matrix}{u}_{1}^{T} \\ {u}_{2}^{T} \\ ⋮ \\ {u}_{{N}_{u}}^{T} ,\end{matrix} ] \qquad ( 43 )$$

In equation (43), Z(u)=\hat{X}(u)fₖ. From this, the initial point for each user is calculated, \hat{X}(u) if the dominant tap k is known and using the circularity-based estimation method described above to estimate the dominant tap and the initial point for each user. This method of initialization works even in the general case where different users have different power delay profiles and dominant taps, as long as they have similar received powers at the base station and the number of scatters/taps are low.

According to an embodiment, to estimate the matrix A in order to find the initial points for each user from equation (39), a single pilot symbol per user is used. The subcarrier allocated as pilot for one user is not allocated to any other user, for data/pilot. Let pᵤ be the pilot subcarrier for user u. Then, the pilot symbol of user u, xₚ_{ᵤ}(u) is known at the base station. Substituting this into equation (42) to obtain (44)

$$[ \begin{matrix}{u}_{1} ( {p}_{1} ) & {u}_{1} ( {p}_{2} ) & … & {u}_{1} ( {p}_{{N}_{u}} ) \\ {u}_{2} ( {p}_{1} ) & {u}_{2} ( {p}_{2} ) & … & {u}_{2} ( {p}_{{N}_{u}} ) \\ ⋮ & ⋮ & ⋱ & ⋮ \\ {u}_{{N}_{u}} ( {p}_{1} ) & {u}_{{N}_{u}} ( {p}_{2} ) & … & {u}_{{N}_{u}} ( {p}_{{N}_{u}} )\end{matrix} ] \approx A [ \begin{matrix}{x}_{{p}_{1}} ( 1 ) \\ {x}_{{p}_{2}} ( 2 ) \\ ⋮ \\ {x}_{{p}_{{N}_{u}}} ( {N}_{u} )\end{matrix} ] , \qquad ( 44 )$$

In equation (44) where uⱼ (pᵤ) is the component pᵤ of j-th left singular vector of Y_{f}. Then each coefficient in A can be calculated as (45).

$${α}_{j}^{u} = {u}_{j} ( {p}_{u} ) / {x}_{{p}_{u}} ( u ) , j = 1 , 2 , … {N}_{u} , u = 1 , 2 , … {N}_{u} . \qquad ( 45 )$$

The matrix of linear coefficients, A calculated as above can now be substituted in equation (43) to obtain the Z(u) corresponding to each user, u∈1, 2, . . . , Nᵤ. The circularity based dominant tap estimation method can be applied to each user's Z(u) independently, from which their initial points \hat{X}(u) can be readily calculated. Further, the de-rotation techniques remain the same as that of the single user. A summarized procedure of blind estimation and de-rotation for multi-user is given in Table 5.

TABLE 5

| | |
|---|---|
| 1: | Input Y_{f}, number of iterations T, initial |
| | point \hat{X} = [\hat{X}(1)\hat{X}(2) . . . \hat{X}(Nᵤ)], pilot |
| | subcarriers {p₁, p₂, . . . p_{N}_{ᵤ}}, pilot symbols |
| | {xₚ_{₁} (1), xₚ_{₂} (2), . . . , xₚ_{_{Nu}} (Nᵤ)}. |
| 2: | Initialize k = 1. B = \|\| |
| 3: | repeat |
| 4: | Ĥ ← (\hat{X} diag(FL)^{†}Y_{f} |
| 5: | B ← diag(F_{L})Ĥ |
| 6: | for n ← 1 to N do |
| 7: | \hat{x}^{T}(n) = y^{T}ₙ(Bₙ)^{†} |
| 8: | end for |
| 9: | If k > 3 then |
| 10: | If k = 4 then |
| 11: | for u ← 1 to Nᵤ do |
| 12: | λᵤ ← \acute{x}ₚ_{ᵤ}(u)/xₚ_{ᵤ}(u). |
| 13: | \hat{X}(u) = \hat{X}(u)/λᵤ |
| 14: | end for |
| 15: | end if |
| 16: | for u ← 1 to Nᵤ do |
| 17: | QAM demodulate \hat{X} (u) → \hat{X}_{d}(u) |
| 18: | QAM modulate \hat{X}_{d}(u) → \hat{X}(u) |
| 19: | end for |
| 20: | end If |
| 21: | k ← k + 1 |
| 22: | until k = T |
| 23: | return \hat{X}, Ĥ |

According to the disclosed techniques, an effective method of channel estimation is disclosed by using modified blind decomposition techniques. Further, the disclosed techniques use single pilot (per user) for estimation which further reduces the overhead of the channel.

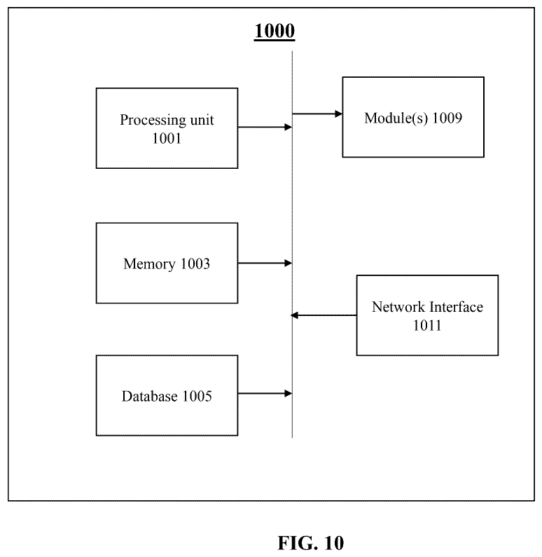

FIG. 10 illustrates a general block diagram of the transmitter/receiver, according to an embodiment of the present disclosure. In an embodiment, the transmitter/receiver 1000 may be the plurality of devices, user equipment, base stations, network entities, and the like.

In an example, the transmitter/receiver 1000 includes a processor(s) that may be a single processing unit or a number of units, all of which could include multiple computing units. The processing unit 1001 may be implemented as one or more microprocessors, microcomputers, microcontrollers, digital signal processors, central processing units, logical processors, virtual processors, state machines, logic circuitries, and/or any devices that manipulate signals based on operational instructions. Among other capabilities, the processing unit 1001 is configured to fetch and execute computer-readable instructions and data stored in the memory 1003.

The memory 1003 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

In an example, the module(s), engine(s), and/or unit(s) 1009 may include a program, a subroutine, a portion of a program, a software component or a hardware component capable of performing a stated task or function. As used herein, the module(s), engine(s), and/or unit(s) may be implemented on a hardware component such as a server independently of other modules, or a module can exist with other modules on the same server, or within the same program. The module (s), engine(s), and/or unit(s) 1009 may be implemented on a hardware component such as processor one or more microprocessors, microcomputers, microcontrollers, digital signal processors, central processing units, state machines, logic circuitries, and/or any devices that manipulate signals based on operational instructions. The module (s), engine(s), and/or unit(s) 1009 when executed by the processor(s) may be configured to perform any of the described functionalities. In an alternate embodiment, the functions of the aforesaid modules may be performed by the processor(s).

As a further example, the database 1005 may be implemented with integrated hardware and software. The hardware may include a hardware disk controller with programmable search capabilities or a software system running on general-purpose hardware. Examples of databases but are not limited to, in-memory databases, cloud databases, distributed databases, embedded databases, and the like. The database amongst other things, serves as a repository for storing data processed, received, and generated by one or more of the processor(s), and the modules/engines/units 1009.

The modules/engines/units 509 may be implemented with an AI module that may include a plurality of neural network layers. Examples of neural networks include, but are not limited to, a convolutional neural network (CNN), a deep neural network (DNN), recurrent neural network (RNN). The learning technique is a method for training a predetermined target device using a plurality of learning data to cause, allow, or control the target device to make a determination or prediction. Examples of the learning techniques include, but are not limited to, supervised learning, unsupervised learning, semi-supervised learning, or reinforcement learning. At least one of a plurality of CNN, DNN, RNN models, and the like may be implemented to thereby achieve execution of the present subject matter's mechanism through an AI model. A function associated with the AI model may be performed through the non-volatile memory, the volatile memory, and the processor. The processor may include one or a plurality of processors. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors control the processing of the input data in accordance with a predefined operating rule or the artificial intelligence (AI) model stored in the non-volatile memory and the volatile memory. The predefined operating rule or artificial intelligence model is provided through training or learning.

As a further example, the network interface 1011 is configured to provide and establish communication with any electronic device via a public network, private network, or any wireless communication technology.

In the above detailed description, reference is made to the accompanying drawings that form a part thereof, and illustrate the best mode presently contemplated for carrying out the invention. However, such description should not be considered as any limitation of scope of the present invention. The structure thus conceived in the present description is susceptible of numerous modifications and variations, all the details may furthermore be replaced with elements having technical equivalence.

1. A method for pilotless communication at a receiver in a wireless communication system, the method comprises:
obtaining digital samples by sampling of a received signal;
determining a received signal matrix (Y_{f}) by arranging the digital samples based on a length of an OFDM symbol (N) and a number of antennas (Nᵣ);
constructing a set of potential initial points for transmitted signal components (\hat{X}) based on a singular vector decomposition (SVD) on the received signal matrix (Y_{f});
estimating a first set of points for the transmitted signal components (\hat{X}) from the set of potential initial points based on at least one of: maximum angular variation in the set of potential initial points and a least circular area of the set of potential initial points;
determining a first channel response ( [symbol] based on at least one of the first set of points (\hat{X}), the received signal, and a regularization parameter (μ);
re-estimating, for a predefined number of iterations, a second set of points for transmitted signal components (\hat{X}) and a second channel response based on the first channel response ( [symbol] , the first set of points (\hat{X}), and the received signal; and
reconstructing the received signal by de-rotating the second set of points for transmitted signal components by a scaling factor (λ).

2. The method as claimed in claim 1, wherein constructing the set of potential initial points comprises:
performing the singular vector decomposition (SVD) on the received signal matrix (Y_{f});
obtaining an orthogonal matrix of left singular vectors (U) based on the SVD on the received signal matrix (Y_{f});
constructing a set of linear equations using a number of the top left singular vectors from the orthogonal matrix (U) which is equal to a number of users;
obtaining a set of modified top left singular vectors by solving the set of linear equations constructed from the set of top left singular vectors using a single pilot signal per user;
performing a multiplication operation on a set of modified top left singular vectors of the orthogonal matrix (U) and a complex conjugate of a DFT matrix (F_{L}); and
constructing the set of potential initial points by multiplying a set of modified top left singular vector of an orthogonal matrix (U) with a complex conjugate of the DFT matrix (F_{L}).

3. The method as claimed in claim 1, wherein estimating the first set of points (\hat{X}) from the set of potential initial points based on maximum angular variation in the set of points comprises:
determining, the distribution of the angles of the potential initial points in the set of potential initial points with respect to a predefined constellation image;
determining the variance of the angular distribution of the potential initial points;
selecting from the set of potential initial points based on the variance of the angular distribution of the potential initial points with respect to the predefined constellation image, wherein points having the maximum angular variance in the set of potential initial points are estimated as the first set of points (\hat{X}).

4. The method as claimed in claim 1, wherein estimating the first set of points (\hat{X}) from the set of potential initial points based on the minimum circularity of the set of points comprises:
determining, a circularity of the set of points based on a ratio of an area and a perimeter of the set of points; and
determining the least circular area of the set of points based on the circularity, wherein points in the set of potential initial points having the least circular area are estimated as the first set of points (\hat{X}).

5. The method as claimed in claim 1, wherein the second set of points are in a rotated order.

6. The method as claimed in claim 1, wherein de-rotating the second set of points comprises:
de-rotating, for a first time, the second set of points using a single pilot signal for each user, wherein the de-rotation of the second set of points for the first time is performed after completion of the predefined number of iterations;
obtaining one or more clusters from the second set of points using clustering techniques and the scaling factor for each user, wherein the number of clusters is based on the predefined constellation image;
plotting a line through one or more centroids of the one or more clusters for each user;
determining a residual correction factor for each user based on the slope of the line; and
de-rotating the second set of points based on the determined residual correction factor for each user.

7. The method as claimed in claim 1, wherein de-rotating the second set of initial points comprises:
de-rotating, for a first time, the second set of points using a single pilot signal and the scaling factor for each user,
wherein the de-rotation of the second set of points for the first time is performed after completion of a number of iterations which is less than the predefined number of iterations;
estimating the second set of points for the first time based on the scaling factor and known information for each user,
performing demodulation and modulation on the second set of points for the first time for each user; and
re-performing the demodulation and the modulation on the second set of points for each iteration after the de-rotation for the first time and until completion of the predefined number of iterations for each user,
wherein the second channel response, for a next iteration after a first iteration, is re-estimated based on the estimated second set of points for the first time.

8. The method as claimed in claim 1, wherein a plurality of rows in the received signal matrix (Y_{f}) corresponds to one or more subcarriers in a frequency domain and a plurality of columns corresponds to one or more antennas of the receiver.

9. The method as claimed in claim 1, wherein the regularization parameter (μ) ranges from 0 to 0.5.

10. A receiver in a wireless communication system for pilotless communication, comprises one or more processors configured to:
obtain digital samples by sampling of a received signal;
determine a received signal matrix (Y_{f}) by arranging the digital samples based on a length of an OFDM symbol (N) and a number of antennas (Nᵣ);
construct a set of potential initial points for transmitted signal components (\hat{X}) based on a singular vector decomposition (SVD) on the received signal matrix (Y);
estimate a first set of points for the transmitted signal components (\hat{X}) from the set of potential initial points based on at least one of: maximum angular variation in the set of potential initial points and a least circular area of the set of potential initial points;
determine a first channel response ( [symbol] based on at least one of the first set of initial points (\hat{X}), the received signal, and a regularization parameter (μ);
re-estimate, for a predefined number of iterations, a second set of points (\hat{X}) for the transmitted signal components and a second channel response based on the first channel response ( [symbol] , the first set of initial points ((\hat{X}), and the received signal; and
reconstruct the received signal by de-rotating the second set of points for the transmitted signal components by a scaling factor (λ).
